(19) United States
(12) Patent Application Publication
(10) Pub. No.: US 2003/0094204 A1
(43) Pub. Date: May 22, 2003

(54) Pressure relief valve

(75) Inventor: Henry Cholod, Wilmington, MA (US)

Correspondence Address: GARY LOSER, VARIAN SEMICONDUCTOR EQUIPMENT ASSOCIATES, 35 DORY ROAD, GLOUCESTER, MA, 01930, US

(73) Assignee: Varian Semiconductor Equipment Associates, Inc.

(21) Appl. No.: 09/988,461

(22) Filed: Nov. 20, 2001

(51) Int. Cl. F16K 15/00

(52) U.S. Cl. 137/543.21

(57) ABSTRACT

A pressure relief valve includes a housing having a passage formed therein for connection with a fluid source and a seal surface positioned about an opening in the passage. A valve member positioned within the housing is movable along an axis within the cavity to selectively engage the seal surface in a sealing relationship. The housing is sized and shaped to substantially restrict movement of the valve member to a direction parallel to the axis. A spring is coupled to the valve member to apply a spring force to the valve member to bias the valve member into contact with the seal surface. In operation, the valve member may separate from the seal surface upon application of a fluid pressure force on the valve member that is greater than the spring force thereby allowing pressurized fluid to pass through a discharge opening in the housing.

### BACKGROUND

Pressure relief valves are typically used to selectively discharge pressurized fluid from a pressure vessel, piping system, or other equipment or sources of pressurized fluid. It is important for a pressure relief valve to reliably open at the set point of valve, i.e. the specified opening pressure of the valve, to avoid potentially dangerous overpressure conditions that can threaten the integrity of the pressure vessel. During normal operation of the pressure vessel, materials within the pressure vessel often collect on the exposed components of the valve, including, for example, the valve seat and the valve member of the valve. The build up of material can interfere with the operation of the valve by, for example, preventing the valve member of the valve from properly seating or causing the valve to open at a pressure higher than the set point of the valve.

### SUMMARY

Pressure relief valves are disclosed herein that may be structured to minimize the buildup of material on the components of the valve and to facilitate the reliable and repeatable operation of the valve.

In accordance with one exemplary embodiment, a pressure relief valve may include a housing having a passage formed therein for connection with a fluid source and a seal surface positioned about an opening in the passage. The housing may include a discharge opening for relieving pressurized fluid from the housing during operation of the relief valve. The pressure relief valve may also include a valve member positioned within the housing. The valve member may be movable along an axis within the cavity to selectively engage the seal surface in a sealing relationship. The housing may be sized and shaped to substantially restrict movement of the valve member to a direction parallel to the axis. The pressure relief valve may include a spring coupled to the valve member and a portion of the housing. The spring may apply a spring force to the valve member to bias the valve member into contact with the seal surface. In operation, the valve member may separate from the seal surface upon application of a fluid pressure force on the valve member that is greater than the spring force thereby allowing pressurized fluid to pass through the discharge opening in the housing.

In certain exemplary embodiments, the valve member of the relief valve may have one or more through-holes formed therein. The one or more through-holes may be arranged on the valve member to inhibit fluid flow through the through-holes when the valve member is sealing engaged with the seal surface. The valve member may have a variety of sizes or shapes. In certain exemplary embodiments, the valve member may be disk-shaped having a generally circular bottom surface for engaging the seal surface. In embodiments in which the valve member is disk shaped, the through-holes may be arranged in a circular pattern about the circumference of the bottom surface.

In certain exemplary embodiments, the valve member may include a spring recess sized to receive at least an end of the spring. The spring recess may be centered on the axis of motion of the valve member. The housing may include a second spring recess sized to receive another end of the spring, the second spring recess being aligned with the spring recess in the valve member.

In certain exemplary embodiments, the housing may include a base and a housing cover engaging the base in a sealing relation ship and enclosing the seal surface within a cavity formed in the cover. The fluid passage connecting with the fluid source may be formed in the base. The cavity within the cover may include the discharge opening for relieving pressurized fluid from the cavity during operation of the relief valve.

### BRIEF DESCRIPTION OF THE DRAWINGS

These and other features and advantages of the devices and methods disclosed herein will be more fully understood by reference to the following detailed description in conjunction with the attached drawings in which like reference numerals refer to like elements through the different views. The drawings illustrate principles of the devices and methods disclosed herein and, although not to scale, show relative dimensions.

FIG. 1 is an exploded perspective view of an exemplary embodiment of a pressure relief valve;

FIG. 2A is side elevational view in cross-section of the pressure relief valve of FIG. 1, illustrating the valve in the closed position;

FIG. 2B is side elevational view in cross-section of the pressure relief valve of FIG. 1, illustrating the valve in the open position;

FIG. 3A is a top view of the base of the pressure relief valve of FIG. 1, illustrating the valve seat;

FIG. 3B is a side elevational view in cross-section of the base of FIG. 3A;

FIG. 4A is bottom view of the valve member of the pressure relief valve of FIG. 1;

FIG. 4B is a side elevational view in cross-section of the valve member of FIG. 4A;

FIG. 5A is a top view of the housing cover of the pressure relief valve of FIG. 1; and

FIG. 5B is a side elevational view in cross-section of the housing cover of FIG. 5A.

### DETAILED DESCRIPTION OF EXEMPLARY EMBODIMENTS

To provide an overall understanding, certain exemplary embodiments will now be described; however, it will be understood by one of ordinary skill in the art that the devices and methods disclosed herein can be adapted and modified to provide devices and methods for other suitable applications and that other additions and modifications can be made without departing from the scope of the disclosure.

Unless otherwise specified, the illustrated embodiments can be understood as providing exemplary features of varying detail of certain embodiments, and therefore features, components, and/or aspects of the illustrations can be otherwise combined, separated, interchanged, and/or rearranged without departing from the present disclosure.

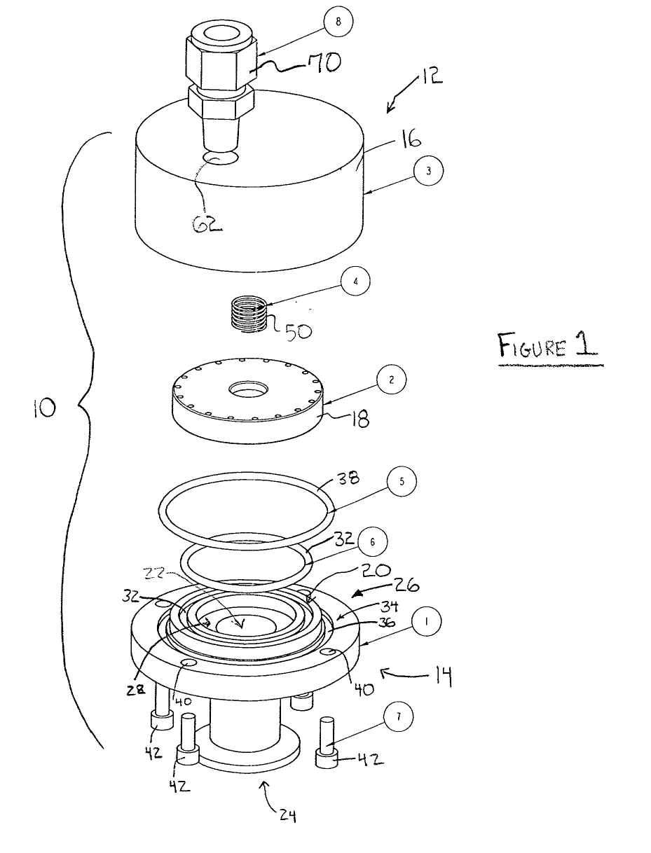

An exemplary embodiment of a pressure relief valve 10 is illustrated in FIG. 1. In the exemplary embodiment of FIG. 1, the valve 10 includes a housing 12 that may comprises a base 14 and a housing cover 16. The exemplary valve 10 also includes a valve member 18 that is positioned with the housing cover 16 and operates to selectively engage a seal surface 20 on the base 14 in a sealing relationship. The exemplary pressure relief valve 10 may be attached to a pressure vessel or other potential source of pressurized fluid to relive fluid pressure from the pressure vessel in overpressure conditions.

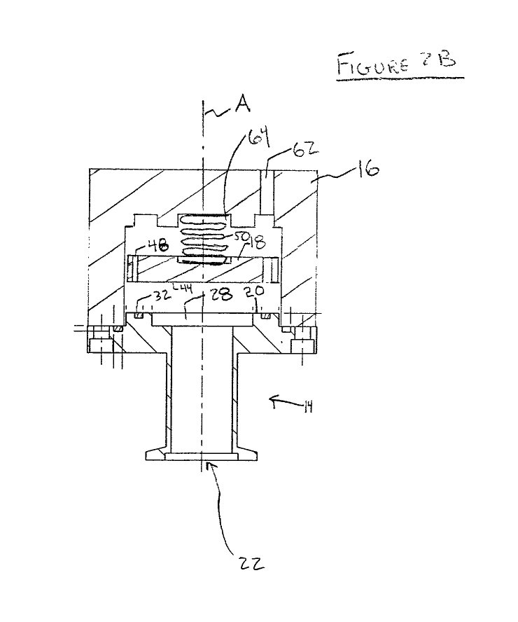

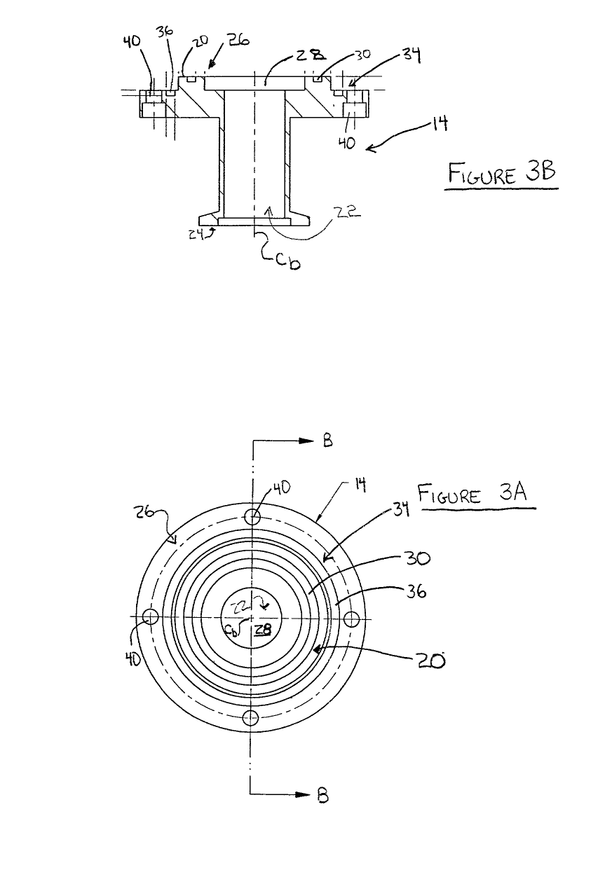

In the exemplary embodiment, the base 14 includes a passage 22 formed through the base 14 for connecting the valve 10 with a fluid source, e.g., a pressure vessel or piping. The base 14, as illustrated in FIGS. 3A and 3B, may be generally mushroom shaped with the passage 22 extending from a bottom surface 24 to a top surface 26 of the base 14. The bottom surface 24 may be an annular flange positioned about an end of the passage 22, as shown in FIG. 3B, or may be any other structure that facilitates the connection of the valve 10 to a source of pressurized fluid. The top surface 26 may include the seal surface 20 that is positioned about an opening 28 at an end of the passage 22. The seal surface 20 forms a valve seat for the valve member 18 to selectively engage in a sealing relationship. The seal surface 20 in the exemplary embodiment is generally annular in shape, although, other shapes are possible, including, for example, elliptical and rectilinear shapes. Referring to FIGS. 1, 3A and 3B, the seal surface 20 in the exemplary embodiment includes an annular groove 30 that is sized and shaped to receive an optional elastomeric seal ring 32, e.g. a rubber O-ring, within the groove 30.

The top surface 26 may also include a secondary seal surface 34 for engaging the housing cover 16 in a sealing relationship. The secondary seal surface 34 is preferably located radially outside of the seal surface 20 and may be shaped in a manner analogous to the seal surface 20. The secondary seal surface 34 in the exemplary embodiment includes an annular groove 36 that is sized and shaped to receive an optional elastomeric seal ring 38, e.g. a rubber O-ring, within the groove 36. One or more bolt holes 40 may also be formed through the secondary seal surface 34 to receive housing bolts 42. Housing bolts 42 may be provided to secure the base 14 to the housing cover 16.

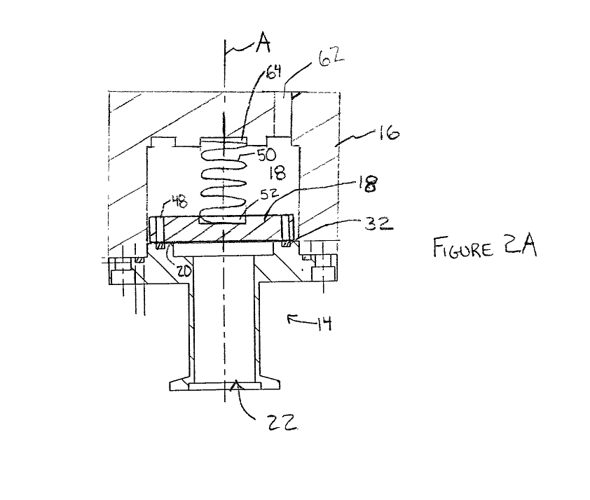

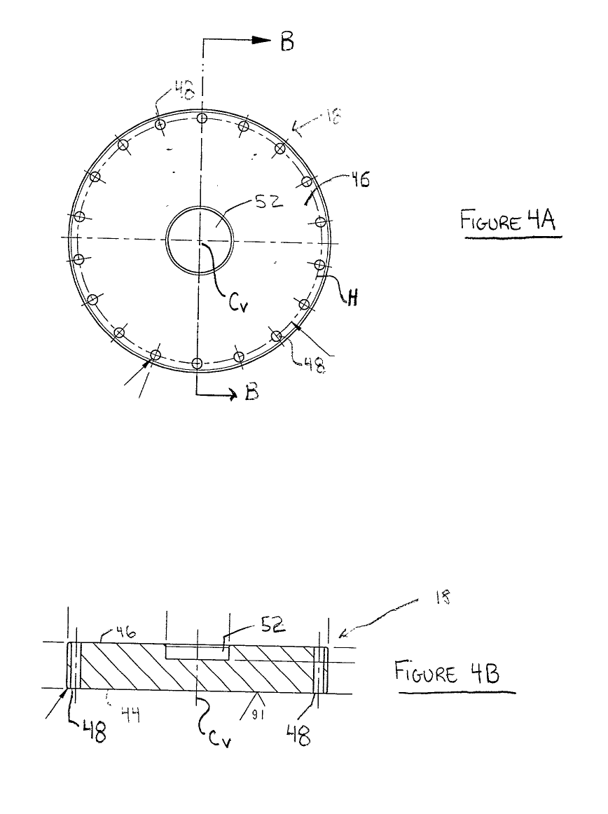

The valve member 18 in the exemplary embodiment may be disk-shaped having a generally circular bottom surface 44 spaced apart from a generally circular top surface 46 that is oriented parallel to the bottom surface 44, as illustrated in FIGS. 1, 4A, and 4B. When the pressure relief valve 10 is closed, the bottom surface 44 of the valve member 18 engages the seal surface 20 to inhibit the flow of fluid through the opening 28 in fluid passage 22. FIG. 2A illustrates the valve member 18 in the closed position, i.e. in sealing contact with the seal surface 20. In the exemplary embodiment, the valve member 18 has one or more through-holes 48 formed through the valve member 18. The through-holes 48 may be provided to permit fluid to flow through the valve member 18 when the pressure relief valve 10 is open, i.e., when the bottom surface 44 of the of the valve member 18 is separated from the seal surface 20. FIG. 2B illustrates the valve member 18 in an open position.

In the exemplary embodiment, the through-holes 48 may be arranged in a circular pattern, illustrated by line H in FIG. 4A, about the circumference of the valve member 18. Preferably; the through-holes 48 are uniform in size and shape and are symmetrically disposed about the circumference of the valve member 18. The through-holes 48 may also be evenly spaced apart. A symmetrical arrangement of commonly structured and spaced through-holes 48 may cause fluid to evenly dissipate through the valve member 18. This arrangement facilitates the valve member 18 maintaining a proper alignment within the housing cover 16 as the valve member moves from a closed position to an open position. One skilled in the art will appreciate, however, that the number, arrangement, and spacing of the through-holes 48 may be varied depending, for example, on the desired volume of fluid pressure to be relieved by the valve 10 and the size of the opening 28 in the passage 22. The through-holes 48 may be arranged on the valve member 18 to inhibit fluid flow through the through-holes 48 when the valve member 18 is in the closed position. For example, the diameter of the circular pattern H may be greater than the diameter of the opening 28 in the fluid passage 22. In embodiments including an elastomeric seal ring 32, the diameter of the circular pattern H may be greater than the diameter of the annular groove 30.

The pressure relief valve 10 may also include a spring 50, illustrated in FIG. 1, that may be coupled to the valve member 18 and a portion of the housing 12. The spring 50 applies a spring force to the valve member 18 to bias the valve member 18 into contact with the seal surface 20. The spring 50 maintains the valve member 18 in a closed position during normal operating conditions. In an over pressure condition, fluid pressure on the bottom surface 44 of the valve member 18 may overcome the spring force on the top surface 46 of the valve member 18, causing the valve 10 to open by separation of the valve member 18 from the seal surface 20. When the valve 10 is open, pressurized fluid may pass through the through-holes 48 in the valve member 18 and/or around the valve member 18 and out a discharge opening 60 in the cover 16 of the housing 12. The opening pressure of the valve 10 may be set by selecting a spring 50 having a corresponding spring force.

Continuing to refer to FIGS. 4A and 4B, the valve member 18 may also include an optional spring recess 52 sized to receive at least an end of the spring 50. The spring recess 52, when present, serves to facilitate the alignment of the spring 50 during operation of the valve 10. The spring recess 52 may have a cross-sectional shape that is analogous to the cross-sectional shape of the spring 50. For example, in the case of a spring 50 having a circular cross-section, as illustrated in FIG. 1, the spring recess 52 also may have a circular cross-section, as illustrated in FIG. 4A. The spring 50, as well as the spring recess 52, may have other cross-sectional shapes. Moreover, the spring 50 may be a coil spring as illustrated or, alternatively, the spring 50 may be any spring type or other biasing mechanism suitable for biasing the valve member 18 into contact with the seal surface 20.

In certain exemplary embodiments, the spring recess 52 may be centered on the axis of motion, indicated by line A in FIGS. 2A and 2B, of the valve member 18. Centering the spring recess 52 may facilitate proper, balanced alignment of the valve member 18 within the housing cover 16 as the valve member 18 moves between an open position and a closed position.

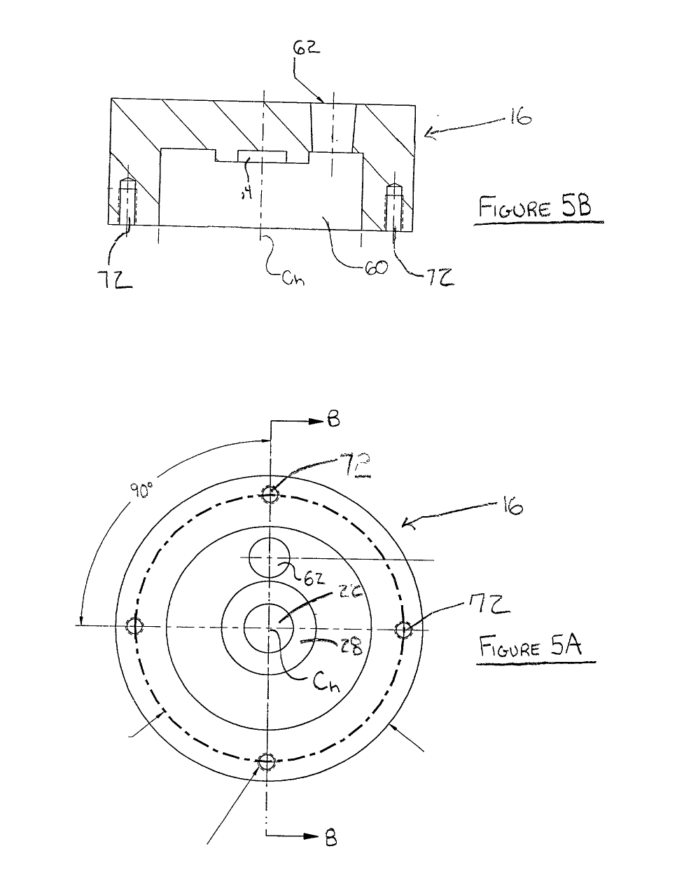

Referring to FIGS. 5A and 5B, the housing cover 16 may be generally cylindrical in shape having a circular cross-section and may include a cavity 60 formed within the housing cover 16. The housing cover 16 may engage the base 14 in a sealing relationship, enclosing the seal surface 20 of the base 14 within the cavity 60. The cavity 60 may be cylindrical in shape and may include a discharge opening 62 for relieving pressurized fluid from the cavity 60 during operation of the relief valve 10. An optional pipe fitting 70 or other connecting structure may be connected to the discharge opening 62 to hard pipe discharged fluid to a remote location. The housing cover 16 may include threaded bolt holes 72 for receiving bolts 42 and securing the housing cover 16 to the base 14.

While the exemplary embodiment of valve 10 includes a two-part housing of the cover 16 and the base 14, one skilled in the art will appreciate that the housing 12 may be a single piece construction or may be constructed from multiple components including more than two components.

The valve member 18 may be movable in a reciprocating manner along an axis of motion A, illustrated in FIG. 2A and 2B, within the cavity 60 to selectively engage the seal surface 20 of the base 14 in a sealing relationship. In certain exemplary embodiments, the axis of motion A of the valve member 18 may be a center-line Cₕ, illustrated in FIGS. 5A and 5B, of the housing cover 14 and the cavity 60. The valve member 18 may be positioned in the cavity 60 such that the center-line Cₕ of the housing cover 16 is coaxial with the center-line Cᵥ, of the valve member 18, illustrated in FIGS. 4A and 4B. The center-line Cₕ of the housing cover 16 may also be coaxially aligned with the center-line C_{b}, of the base 14, illustrated in FIGS. 3A and 3B. Thus, in certain exemplary embodiments, the center-line Cₕ of the housing cover 16, the center-line Cᵥ, of the valve member 18, and the center-line C_{b}, of the base 14 may be coaxially aligned and the axis of motion A of the valve member 18 may be along the coaxial center-line of the housing cover 16, the valve member 18, and the base 14. FIGS. 2A and 2B illustrate an exemplary embodiment of the valve 10 in which the center-lines of the housing cover 16, the member 18, and the base 14 are coaxially aligned.

The cavity 60 of the housing cover 16 may be sized and shaped to substantially restrict movement of the valve member 18 to a direction parallel to the axis of motion A of the valve member 18, as illustrated in FIGS. 2A and 2B. In the exemplary embodiment illustrated in FIGS. 2A and 2B, the housing cavity 60 has a cross-sectional shape analogous to the cross-sectional shape of the valve member 18 and the clearance between the valve member 18 and the walls of the cavity 60 is minimized, such that the diameter of the cavity 60 is approximate to the diameter of valve member 18. In certain exemplary embodiments, the clearance between the valve member 18 and the walls of the cavity 60 is less or equal to 0.10 inches. In other exemplary embodiments, the clearance is less than or equal to approximately 0.02 inches.

The housing cover 16 may include a second spring recess 64 sized to receive another end of the spring 50. The second spring recess 64 may be aligned with the spring recess 52 in the valve member 18. In the exemplary embodiment illustrated in FIGS. 2A and 2B, the spring recess 52 and the second spring recess 64 are coaxially aligned on the coaxial centerline of the housing cover 16, the valve member 18, and the base 14.

The components of the exemplary valve 10, such as the housing cover 16, the base 14, and the valve member 18, may be constructed from metals, including for, example, stainless steel or aluminum, plastics, or other materials suitable for constructing fluid handling components. The particular material of the pressure relief valve may be selected based on the environment in which the valve is intended to operate and the fluid(s) to which the valve 10 may be exposed.

In operation, the spring 50 of the exemplary valve 10 illustrated in FIGS. 2A and 2B biases the valve member 18 into a closed position in which the valve member 18 is in contact with the seal surface 20. In the closed position illustrated in FIG. 2A, fluid may not flow through or by the valve member 18 from the fluid passage 22. The through-holes 48 in the valve member 18 of the exemplary valve 10 are radially distal from the opening 28 in the fluid passage 22 and may be further isolated from the fluid within the fluid passage 22 by the optional elastomeric seal ring 32. This arrangement of the through-holes 48 may inhibit the build-up of materials from the fluid on the through-holes 48 and/or the edges of the valve member 18. In an overpressure condition, the force of fluid pressure on the bottom surface 44 of the valve member 18 is greater that the spring force on the top surface 46 of the valve member 18, causing the valve member 18 to separate from the seal surface 20, as illustrated in FIG. 2B. In this open position, fluid may pass through the through-holes 48 and/or between the valve member 18 and the walls of the cavity 60 and out of the valve 10 via the discharge opening 62. As the fluid pressure is reduced, the spring 50 returns the valve member 18 to a closed position in contact with the seal surface 20.

Since certain changes may be made in the above constructions without departing from the scope of the present disclosure, it is intended that all matter contained in the above description or shown in the accompanying drawings be interpreted as illustrative and not in a limiting sense.

It is also to be understood that the following claims are to cover all generic and specific features of the devices and methods described herein.

1. A pressure relief valve comprising:
a housing having a passage formed therein for connection with a fluid source and a seal surface positioned about an opening in the passage, the housing including a discharge opening for relieving pressurized fluid from the housing during operation of the relief valve;
a valve member positioned within the housing, the valve member being movable along an axis within the housing to selectively engage the seal surface in a sealing relationship, the housing being sized and shaped to substantially restrict movement of the valve member to a direction parallel to the axis; and
a spring coupled to the valve member and a portion of the housing, the spring applying a spring force to the valve member to bias the valve member into contact with the seal surface, wherein the valve member separates from the seal surface upon application of a fluid pressure force on the valve member that is greater than the spring force thereby allowing pressurized fluid to pass through the discharge opening in the housing.

2. The relief valve of claim 1, wherein the valve member has one or more through-holes formed therein.

3. The relief valve of claim 2, wherein the one or more through-holes are arranged on the valve member to inhibit fluid flow through the through-holes when the valve member is sealing engaged with the seal surface.

4. The relief valve of claim 3, wherein the seal surface is generally annular in shape.

5. The relief valve of claim 4, wherein the valve member is disk-shaped having a generally circular bottom surface for engaging the seal surface.

6. The relief valve of claim 5, wherein the holes are arranged in a circular pattern about the circumference of the bottom surface.

7. The relief valve of claim 2, wherein the through-holes are uniformly spaced about the valve member.

8. The relief valve of claim 7, wherein the through-holes are commonly sized and shaped.

9. The relief valve of claim 1, wherein the seal surface has an annular groove formed therein for receiving an elastomeric seal ring.

10. The relief valve of claim 1, wherein the valve member includes a spring recess sized to receive at least an end of the spring.

11. The relief valve of claim 10, wherein the spring recess is centered on the axis of motion of the valve member.

12. The relief valve of claim 1, wherein the housing includes a second spring recess sized to receive another end of the spring, the second spring recess being aligned with the spring recess in the valve member.

13. A pressure relief valve comprising:
a housing having a passage formed therein for connection with a fluid source and a seal surface positioned about an opening in the passage, the housing including a discharge opening for relieving pressurized fluid from the housing during operation of the relief valve;
a valve member positioned within the housing, the valve member being movable in a reciprocating manner along an axis within the housing to selectively engage the seal surface of the base in a sealing relationship, the valve member having one or more through-holes formed therein; and
a spring coupled to the valve member and applying a spring force to the valve member to bias the valve member into contact with the seal surface, wherein the valve member separates from the seal surface upon application of a fluid pressure force on the valve member that is greater than the spring force thereby allowing pressurized fluid to pass through the through-holes in the valve member and out of the valve through the discharge opening in the cover.

14. The relief valve of claim 13, wherein the seal surface is generally annular in shape.

15. The relief valve of claim 14, wherein the valve member is disk-shaped having a generally circular bottom surface for engaging the seal surface.

16. The relief valve of claim 15, wherein the holes are arranged in a circular pattern about the circumference of the bottom surface.

17. The relief valve of claim 14, wherein the diameter of the circular pattern is greater than the width of the opening in the passage.

18. The relief valve of claim 13, wherein the one or more through-holes are arranged on the valve member to inhibit fluid flow through the through-holes when the valve member is sealingly engaged with the seal surface of the base.

19. The relief valve of claim 18, wherein the through-holes are uniformly spaced in a pattern about the valve member.

20. The relief valve of claim 19, wherein the through-holes are commonly sized and shaped.

21. The relief valve of claim 20, wherein the pattern of through-holes is circular in shape, and a diameter of the pattern is greater than the width of the opening in the passage

22. A pressure relief valve comprising:
a base having passage formed therein for connection with a fluid source and a seal surface positioned about an opening in the passage;
a housing cover having a cylindrical cavity formed therein, the cover engaging the base in a sealing relation ship and enclosing the seal surface within the cavity, the cavity including a discharge opening for relieving pressurized fluid from the cavity during operation of the relief valve;
a disk-shaped valve member positioned within the cavity, the valve member being movable in a reciprocating manner along a center-line axis of the cavity such that a bottom surface of the valve member selectively engages the seal surface of the base in a sealing relationship, the cavity having a diameter approximate to the diameter of the valve member to substantially restrict movement of the valve member to a direction parallel to the center-line axis, the valve member having plurality of through-holes formed therein, the holes being arranged in a circular pattern about the circumference of the bottom surface of the valve member, the circular pattern having a diameter greater than a width of the opening to inhibit fluid flow through the through-holes when the bottom surface of the valve member is sealingly engaged with the seal surface of the base; and
a spring coupled to the valve member and to the cover, the spring applying a spring force to the valve member to bias the valve member into contact with the seal surface, wherein the valve member separates from the seal surface upon application of a fluid pressure force on the valve member that is greater than the spring force thereby allowing pressurized fluid to pass through the through-holes in the valve member and out of the valve through the discharge opening in the cover.
